(19) United States
(12) Patent Application Publication
(10) Pub. No.: US 2018/0323721 A1
(43) Pub. Date: Nov. 8, 2018

(54) POWER SUPPLY

(71) Applicant: Dyson Technology Limited, Wiltshire (GB)

(72) Inventor: Stephen GREETHAM, Gloucester (GB)

(73) Assignees: Dyson Technology Limited, Wiltshire (GB); Dyson Technology Limited, Wiltshire (GB)

(21) Appl. No.: 15/746,406

(22) PCT Filed: Jun. 30, 2016
(86) PCT No.: PCT/GB2016/051980

§ 371 Date: Jan. 19, 2018

(30) Foreign Application Priority Data
Jul. 21, 2015 (GB) 1512848.1

(51) Int. Cl. H02M 3/335; H02J 7/00; H02M 1/44; H02M 1/42; A47L 9/28

(52) U.S. Cl. CPC H02M 3/33592; H02J 7/0068; H02M 2001/0048; H02M 1/4208; A47L 9/2878; H02M 1/44

(57) ABSTRACT

A power supply that operates in two modes comprising input terminals for connection to an AC source, output terminals for connection to a load, an AC-to-DC stage, and a battery. When operating in the first mode, the load draws current from the battery only. When operating in the second mode, the load draws current from both the battery and the AC-to-DC stage. The current drawn by the load is then greater than the current output by the AC-to-DC stage during first periods, and is less than the current output by the AC-to-DC stage during second periods. The load draws current from the battery and the AC-to-DC stage during the first periods such that the battery discharges, and the load and the battery each draw current from the AC-to-DC stage during the second periods such that the battery charges.

The present invention relates to a power supply capable of powering a load from an AC source or a battery.

A power supply may comprise an AC-to-DC stage and a battery. When the power supply is connected to an AC source, the AC-to-DC stage outputs a regular current or voltage which is used to power the load as well as charge the battery. When the power supply is disconnected from the AC source, the battery alone powers the load.

The AC-to-DC stage may include a power factor correction (PFC) circuit that outputs a regular current or voltage whilst ensuring that the current drawn from the AC source is substantially sinusoidal. In order to achieve this, the PFC circuit generally comprises a capacitor of high capacitance. As a consequence of the high capacitance, the capacitor is physically large and expensive.

The present invention provides a power supply comprising: input terminals for connection to an AC source; output terminals for connection to a load; an AC-to-DC stage; and a battery, wherein the AC-to-DC stage and the battery are connected in parallel between the input terminals and the output terminals, the power supply operates in either a first mode or a second mode, the load draws current from only the battery when operating in the first mode, the load draws current from both the battery and the AC-to-DC stage when operating in the second mode, and when operating in the second mode: the AC-to-DC stage draws an input current from the AC source and outputs an output current having a waveform that is periodic with a frequency twice that of the input current and a ripple of at least 50%; the current drawn by the load is greater than the output current during first periods; the current drawn by the load is less than the output current during second periods; the load draws current from the battery and the AC-to-DC stage during the first periods such that the battery discharges; and the load and the battery each draw current from the AC-to-DC stage during the second periods such that the battery charges.

The power supply is intended to operate in the first mode when disconnected from the AC source. Power to the load is then supplied by the battery only. When connected to the AC source, the power supply is intended to operate in the second mode. Power to the load is then supplied by the AC source. Conceivably, power may additionally be supplied by the battery. For example, the battery may be used to boost the power drawn from the AC source. Irrespective of whether power is supplied solely by the AC source or by both the AC source and the battery, the load draws current from both the battery and the AC-to-DC stage when operating in the second mode.

The AC-to-DC stage has little or no storage capacitance. This then has the advantage that the size and cost of the power supply may be reduced. However, as a consequence of the low storage capacitance, the output current of the AC-to-DC stage has a relatively high ripple. There are then first periods during which the current drawn by the load is greater than that output current, and there are second periods during which the current drawn by the load is less than that output current. During each first period, the load draws the deficit current from the battery, which in turn causes the battery to discharge. During each second period, the surplus current not drawn by the load is instead drawn by the battery, which in turn causes the battery to charge. The battery therefore acts as a storage device for the AC-to-DC stage when the power supply operates in the second mode. Consequently, in spite of the ripple in the output current of the AC-to-DC stage, the power supply is able to meet the current demands of the load.

There may be at least one first period and at least one second period over each cycle of the output current of the AC-to-DC stage. The battery is therefore charged and discharged during each cycle of the output current. As a result, a relatively constant state of charge may be achieved for the battery, which may help prolong the life of the battery.

If the charge drawn from the battery during the first periods is greater than the charge drawn by the battery during the second periods, the battery will experience net discharging. Conversely, if the charge drawn from the battery during the first periods is less than the charge drawn by the battery during the second periods, the battery will experience net charging. The charge drawn from and by the battery will depend on the current demand of the load and the amplitude of the output current, which in turn depends on by the amplitude of the input current. The AC-to-DC stage may therefore adjust the input current in order to control net charging and discharging of the battery. Additionally or alternatively, the AC-to-DC stage may adjust the input current in order to avoid excessive battery currents and/or excessive battery temperatures. Accordingly, the AC-to-DC stage may adjust the input current in response to changes in one of: (i) the voltage of the battery, (ii) the current drawn from or by the battery, (iii) the temperature of the battery, and (iv) the power demand of the load.

The AC-to-DC stage may adjust the input current in response to changes in the voltage of the battery such that the average value of the output current is constant. This then has the advantage that the battery is charged with a constant average current.

The AC-to-DC stage may adjust the input current in response to changes in the voltage of the battery so as to avoid over-voltage and/or under-voltage, which might otherwise damage the battery. Additionally or alternatively, the AC-to-DC stage may adjust the input current so as to charge the battery until a state of full charge has been reached, and then to hold the battery at a voltage close to full charge. For example, when the voltage of the battery is below an upper threshold corresponding to full charge, the AC-to-DC stage may set the input current such that, over each cycle of the output current, the charge drawn from the battery during the first periods is less than the charge drawn by the battery during the second periods. As a result, the battery experiences net charging. When the voltage of the battery subsequently rises above the upper threshold, the AC-to-DC stage may decrease the input current such that, over each cycle of the output current, the charge drawn from the battery during the first periods is greater than the charge drawn by the battery during the second periods. As a result, the battery experiences net discharging. Discharging of the battery then continues until the voltage of the battery drops below a lower threshold. When the voltage of the battery drops below the lower threshold, the AC-to-DC stage may increase the input current to its previous value such that the battery again experiences net charging. The voltage of the battery is therefore chopped between the upper threshold and the lower threshold. By selecting appropriate values for the upper and lower thresholds, the battery may be held at a voltage close to full charge.

Since the output terminals of the power supply are held at the battery voltage, any change in the power demand of the load will result in a change in the current drawn by the load. Since the AC-to-DC stage acts as a current source, any change in the current drawn by the load must be accompanied by a change in the currents drawn from and by the battery. As noted above, excessive currents and/or excessive rates of charge and discharge may damage the battery. Accordingly, the AC-to-DC stage may adjust the input current in response to changes in the power demand of the load. In particular, the AC-to-DC stage may decrease the input current in response to a decrease in the power demand of the load.

The load may have a low-power mode and a high-power mode, and the power demand of the load may be lower when in low-power mode. The AC-to-DC stage may then adjust the input current such that the output current is lower when the load is in low-power mode. As a result, similar rates of charging and discharging may be achieved irrespective of the power mode in which the load operates.

The AC-to-DC stage may comprises a power factor correction (PFC) circuit that regulates the input current drawn from the AC source but does not regulate the output voltage of the AC-to-DC stage. As a result, the voltage-control loop employed by conventional PFC circuits may be omitted, thus reducing the cost and/or complexity of the PFC circuit. Furthermore, a conventional PFC circuit typically requires a capacitor of high capacitance in order to output a regular output voltage. Since the voltage of the battery is reflected back to the PFC circuit, the PFC circuit is not required to regulate the output voltage. As a result, the PFC circuit is able to employ a capacitor of much smaller capacitance. Consequently, the size and/or cost of the PFC circuit may be further reduced.

The PFC circuit may employ a current reference for regulating the input current drawn from the AC source, and the PFC circuit may adjust the current reference in response to changes in one of: (i) the voltage of the battery, (ii) the current drawn from or by the battery, (iii) the temperature of the battery, or (iv) the power demand of the load. For example, the current reference may be a rectified sinusoid, and the PFC circuit may adjust the amplitude of the rectified sinusoid. Alternatively, the current reference may be a PWM signal, and the PFC circuit may adjust the duty cycle or frequency of the PWM signal.

The AC-to-DC stage may comprise a step-down DC-to-DC converter located between the PFC circuit and the output terminals. The voltage conversion ratio of the DC-to-DC converter may then be defined such that the peak value of the input voltage, when stepped down, is less than the minimum voltage of the battery. This then has the advantage that the PFC circuit is able to operate in boost mode to provide continuous current control.

The DC-to-DC converter may comprise a resonant converter having one or more primary-side switches that are switched at a constant frequency. Employing a resonant converter has the advantage that the desired voltage conversion ratio may be achieved through the turns ratio of the transformer. Additionally, a resonant converter is able to operate at higher switching frequencies than a comparable PWM converter and is capable of zero-voltage switching. By switching the primary-side switches at a constant frequency, a relatively simple controller may be employed by the DC-to-DC converter. Switching at a constant frequency is made possible because the DC-to-DC converter is not required to regulate or otherwise control the output voltage. In contrast, the DC-to-DC converter of a conventional power supply is generally required to regulate the output voltage and thus requires a more complex and expensive controller in order to vary the switching frequency.

The DC-to-DC converter may have one or more secondary-side switches that are switched at the same constant frequency as that of the primary-side switches. A relatively simple and cheap controller may therefore be employed on the secondary side. Moreover, a single controller could conceivably be employed to control both the primary-side and the secondary-side switches.

The present invention also provides an electrical system comprising a load connected to the output terminals of a power supply as described in any one of the previous paragraphs.

Over each cycle of the output current output by the AC-to-DC stage, the current drawn by the load may be relatively regular. In particular, the current drawn by the load may have a ripple less than 10%. In contrast, the output current of the AC-to-DC stage has a ripple of at least 50%. Nevertheless, by employing a battery that is both charged and discharged during each cycle of the output current, the power supply is able to meet the current demand of the load throughout each cycle.

The present invention further provides a vacuum cleaner comprising a vacuum motor connected to the output terminals of a power supply as described in any one of the previous paragraphs.

For the purposes of clarity, the following terms should be understood to have the following meanings. The term ‘waveform’ refers to the shape of a signal and is independent of the amplitude or phase of the signal. The terms ‘amplitude’ and ‘peak value’ are synonymous and refer to the absolute maximum value of the signal. The term ‘ripple’ is expressed herein as a peak-to-peak percentage of the maximum value of the signal. Finally, the term ‘average value’ refers to the average of the absolute instantaneous values of a signal over one cycle.

In order that the present invention may be more readily understood, embodiments of the invention will now be described, by way of example, with reference to the accompanying drawings, in which:

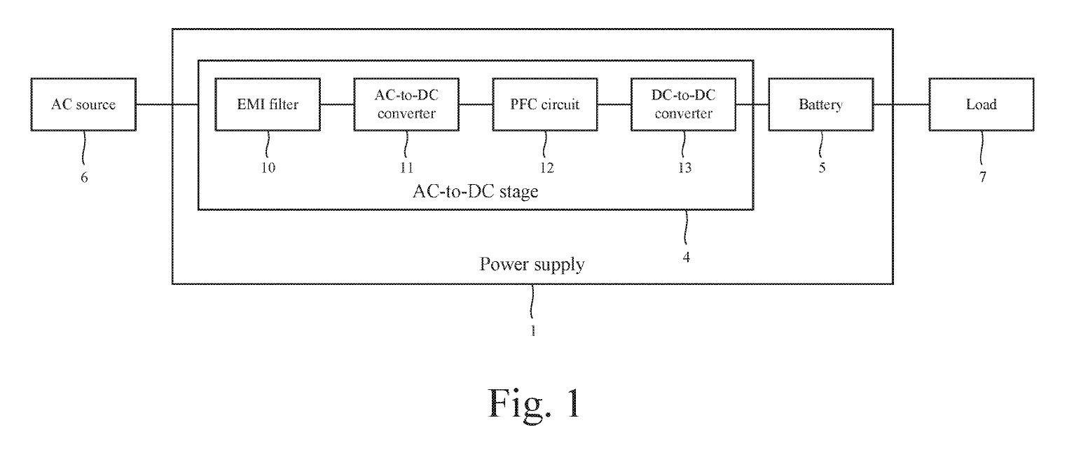

FIG. 1 is a block diagram of a power supply in accordance with the present invention;

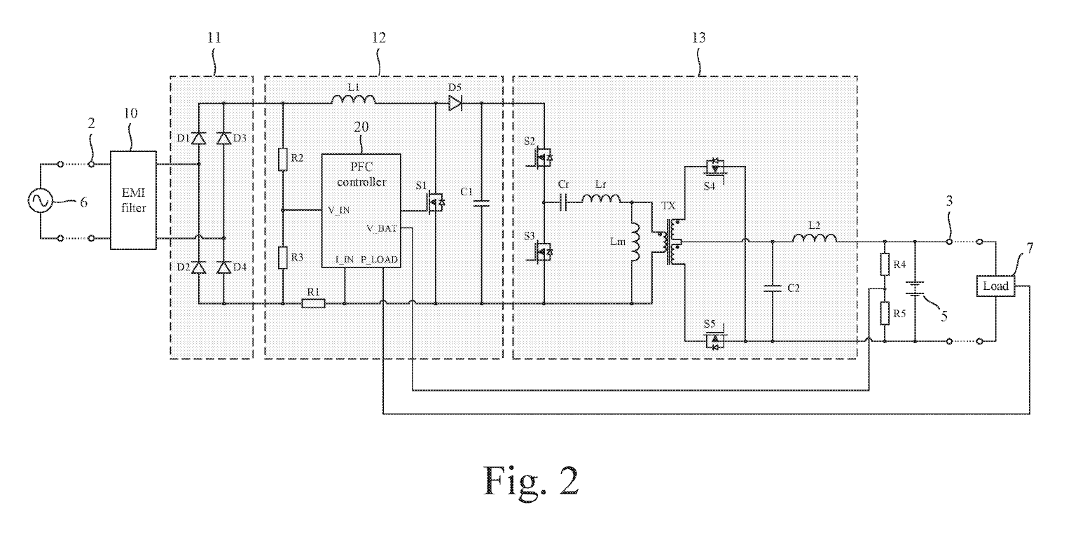

FIG. 2 is a circuit diagram of the power supply;

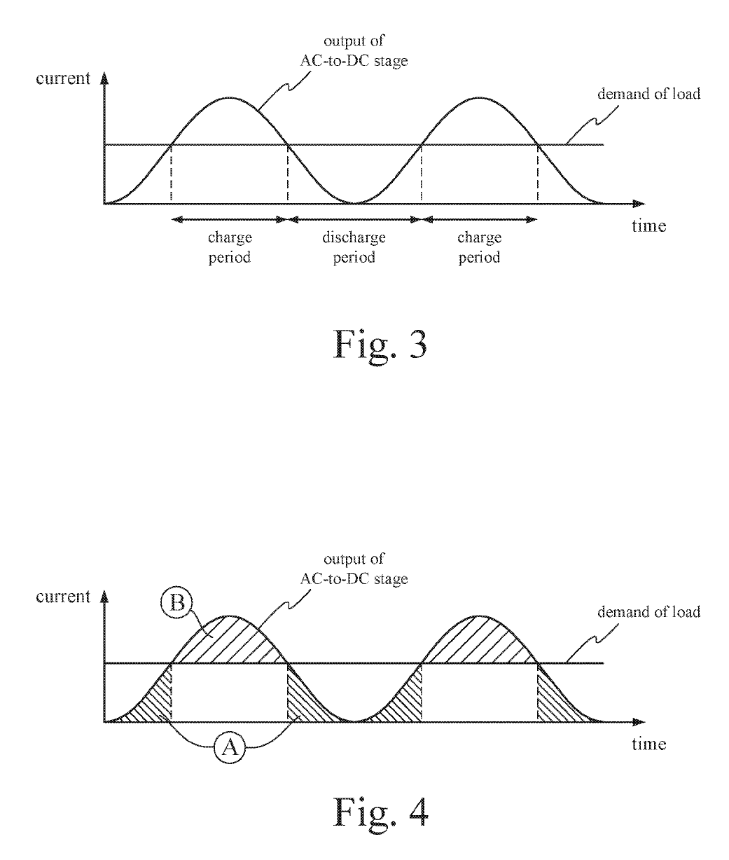

FIG. 3 illustrates the output current of an AC-to-DC stage of the power supply, and the current demand of a load connected to the power supply;

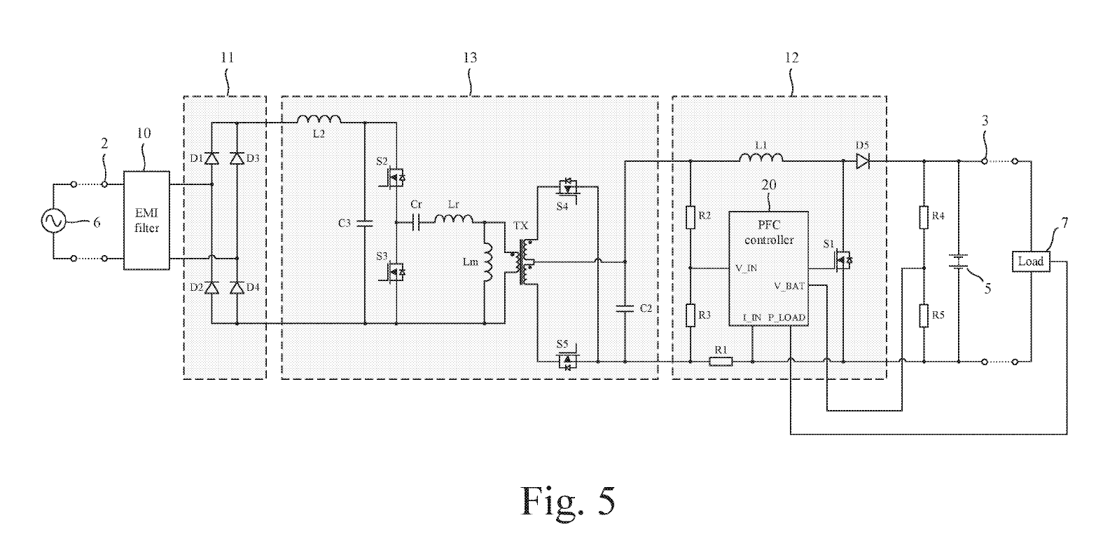

FIG. 4 illustrates the same waveforms as that of FIG. 3, wherein the total charge drawn from (region A) and by (region B) a battery of the power supply is shown;

FIG. 5 is a circuit diagram of a first alternative power supply in accordance with the present invention;

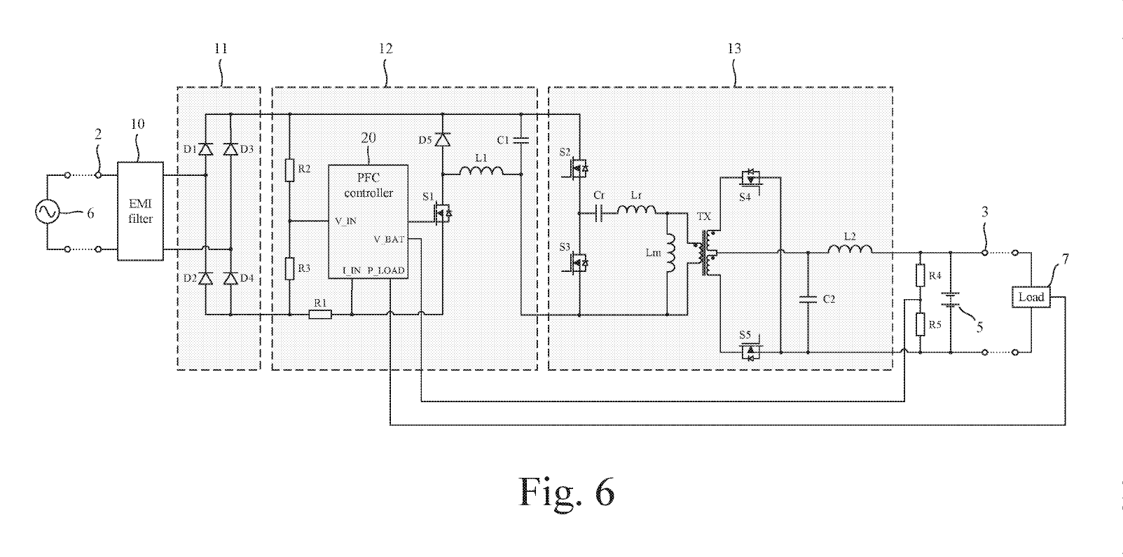

FIG. 6 is a circuit diagram of a second alternative power supply in accordance with the present invention;

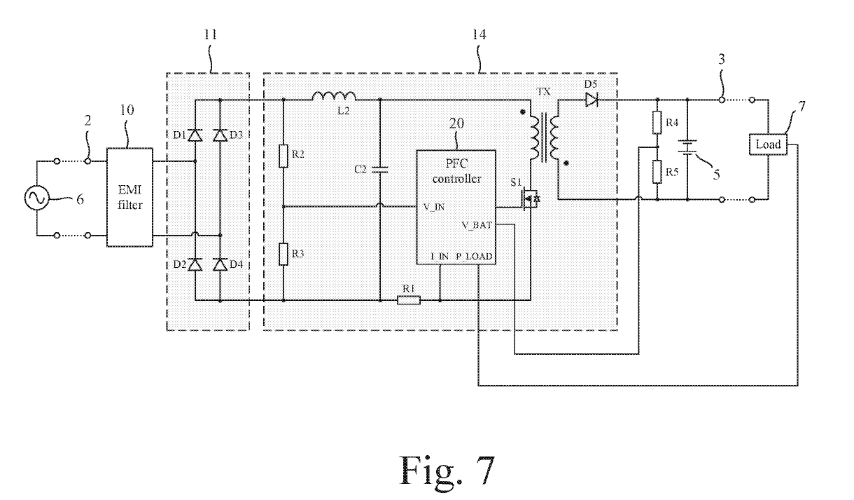

FIG. 7 is a circuit diagram of a third alternative power supply in accordance with the present invention;

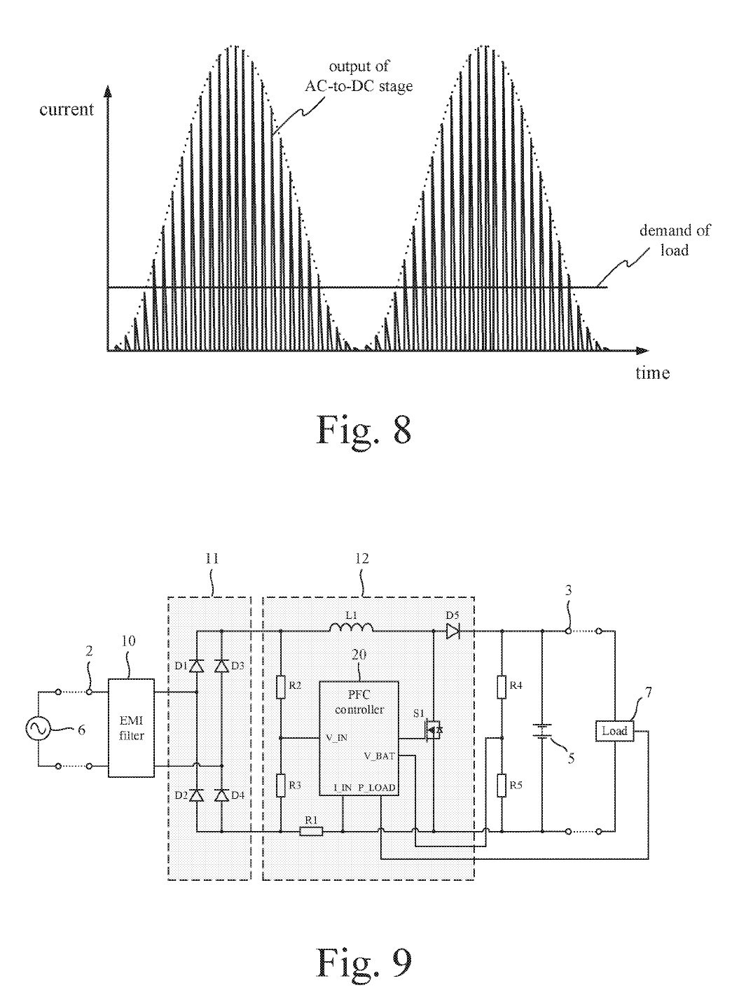

FIG. 8 illustrates the output current of an AC-to-DC stage of the power supply of FIG. 7, and the current demand of a load connected to the power supply;

FIG. 9 is a circuit diagram of a fourth alternative power supply in accordance with the present invention; and

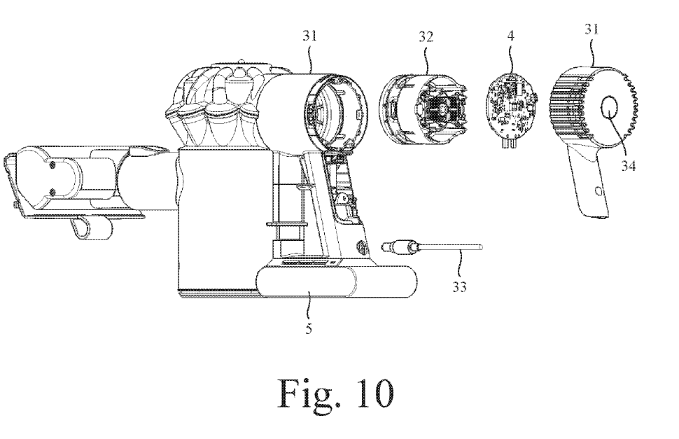

FIG. 10 is a partially exploded view of a vacuum cleaner comprising a power supply of the present invention.

The power supply 1 of FIGS. 1 and 2 comprises input terminals 2, output terminals 3, an AC-to-DC stage 4, and a battery 5. The input terminals 2 are connectable to an AC source 6 supplying an alternating input voltage, and the output terminals 3 are connectable to a load 7. The AC-to-DC stage 4 and the battery 5 are then connected in parallel between the input terminals 2 and the output terminals 3.

The AC-to-DC stage 4 comprises an electromagnetic interference (EMI) filter 10, an AC-to-DC converter 11, a power factor correction (PFC) circuit 12, and a DC-to-DC converter 13.

The EMI filter 10 is used to attenuate high-frequency harmonics in the input current drawn from the AC source 6.

The AC-to-DC converter 11 comprises a bridge rectifier D1-D4 providing full-wave rectification.

The PFC circuit 12 comprises a boost converter located between the AC-to-DC converter 11 and the DC-to-DC converter 13. The boost converter comprises an inductor L1, a capacitor C1, a diode D5, a switch S1 and a control circuit. The inductor, capacitor, diode and switch are arranged in a conventional arrangement. Consequently, the inductor L1 is energised when the switch S1 is closed, and energy from the inductor L1 is transferred to the capacitor C1 when the switch S1 is opened. Opening and closing of the switch Si is then controlled by the control circuit.

The control circuit comprises a current sensor R1, a voltage sensor R2,R3, and a PFC controller 20. The current sensor R1 outputs the signal I_IN, which provides a measure of the input current drawn from the AC source 6. The voltage sensor R2,R3 outputs the signal V_IN, which provides a measure of the input voltage of the AC source 6. The current sensor R1 and the voltage sensor R2,R3 are located on the DC side of the AC-to-DC converter 11. Consequently, I_IN and V_IN are rectified forms of the input current and the input voltage. Both signals are output to the PFC controller 20. The PFC controller 20 scales V_IN in order to generate a current reference. The PFC controller 20 then uses the current reference to regulate the input current I_IN. There are various control schemes that the PFC controller 20 might employ in order to regulate the input current. For example, the PFC controller 20 might employ peak, average or hysteretic current control. Such control schemes are well known and it is not therefore the intention here to describe a particular scheme in any detail. The PFC controller 20 receives two further input signals: V_BAT and P_LOAD. V_BAT provides a measure of the voltage of the battery 5 and is output by a further voltage sensor R4,R5. P_LOAD provides a measure of the power demand of the load 7 and is output by the load 7. As described below, the PFC controller 20 regulates the input current drawn from the AC source 6 in response to changes in the battery voltage and the power demand of the load 7. This is achieved by adjusting the amplitude of the current reference (i.e. by scaling V_IN) in response to changes in V_BAT and P_LOAD.

The DC-to-DC converter 13 comprises a half-bridge LLC series resonant converter that comprises a pair of primary-side switches S2,S3, a primary-side controller (not shown) for controlling the primary-side switches, a resonant network Cr,Lr, a transformer Tx, a pair of secondary-side switches S4,S5, a secondary-side controller (not shown) for controlling the secondary-side switches, and a low-pass filter C2,L2. The primary-side controller switches the primary-side switches S2,S3 at a fixed frequency defined by the resonance of Cr and Lr. Similarly, the secondary-side controller switches the secondary-side switches S4,S5 at the same fixed frequency so as to achieve synchronous rectification. The low-pass filter C2,L2 then removes the high-frequency current ripple that arises from the switching frequency of the converter 13.

The impedance of the DC-to-DC converter 13 is relatively low. As a consequence, the voltage at the output of the PFC circuit 12 is held at a level defined by the voltage of the battery 5. More specifically, the voltage at the output of the PFC circuit 12 is held at the battery voltage multiplied by the turns ratio of the DC-to-DC converter 13. In order to simplify the following discussion, the term ‘stepped battery voltage’ will be used when referring to the battery voltage, V_BAT, multiplied by the turns ratio, Np/Ns.

On opening the switch S1 of the PFC circuit 12, energy from the inductor L1 is transferred to the capacitor C1, causing the capacitor voltage to rise. As soon as the capacitor voltage reaches the stepped battery voltage, energy from the inductor L1 is transferred to the battery 5. Owing to the relatively low impedance of the DC-to-DC converter 13, the voltage of the capacitor C1 does not rise any further but is instead held at the stepped battery voltage. On closing the switch Si of the PFC circuit 12, the capacitor C1 discharges only when there is a difference between the capacitor voltage and the stepped battery voltage. As a result, the capacitor C1 continues to be held at the stepped battery voltage after the switch S1 has been closed. The voltage of the battery 5 is therefore reflected back to the PFC circuit 12.

The flow of charge between the PFC circuit 12 and the battery 5 is somewhat analogous to the flow of water between two bodies separated by a weir. The capacitor C1 of the PFC circuit 12 may be regarded as a relatively small pond on one side of the weir, and the battery 5 may be regarded as a relatively large lake on the opposite side of the weir. The height of the weir then represents the magnitude of the stepped battery voltage. When the switch S1 of the PFC circuit 12 is opened, the inductor L1 transfers water to the pond, thus causing the level of water within the pond to rise (i.e. the capacitor voltage rises). When the water within the pond reaches the height of the weir, any further water flowing into the pond immediately spills over the weir and into the lake (i.e. when the capacitor voltage reaches the stepped battery voltage, any further charge flows to the battery). Thereafter, the pond is held at the same height as that of the lake (i.e. the capacitor is held at the stepped battery voltage). When the switch S1 of the PFC circuit 12 is subsequently closed, the flow of water to the pond and the lake is halted. The level of water within the pond is then held at the height of the weir (i.e. the capacitor voltage is held at the stepped battery voltage). Owing to the size of the lake (i.e. the charge capacity of the battery), the water flowing over the weir when the switch S1 is opened makes little difference to the overall height of the lake. Equally, the water drawn from the lake by the load 7 when the switch S1 is closed makes little difference to the height of the lake (i.e. the charge drawn by and from the battery makes little difference to the battery voltage). Consequently, there is a negligible change in the voltage of the battery 5 during each opening and closing of the switch S1.

In order that the PFC circuit 12 is able to control continuously the input current drawn from the AC source 6, it is necessary to maintain the capacitor voltage at a level greater than the peak value of the input voltage of the AC source 6. Since the capacitor C1 is held at the stepped battery voltage, it is necessary to maintain the stepped battery voltage at a level greater than the peak value of the input voltage. Moreover, this condition must be met over the full voltage range of the battery 5. Consequently, the turns ratio of the DC-to-DC converter 13 may be defined as:

Np/Ns>V_IN(peak)/V_BAT(min).

where Np/Ns is the turns ratio, V_IN(peak) is the peak value of the input voltage of the AC source 6, and V_BAT(min) is the minimum voltage of the battery 5.

The PFC circuit 12 ensures that the input current drawn from the AC source 6 is substantially sinusoidal. Since the input voltage of the AC source 6 is sinusoidal, the input power drawn from the AC source 6 by the AC-to-DC stage 4 has a sine-squared waveform. Since the AC-to-DC stage 4 has very little storage capacity, the output power of the AC-to-DC stage 4 has substantially the same shape as the input power, i.e. the output power also has a sine-squared waveform. The output voltage of the AC-to-DC stage 4 is held at the battery voltage. Consequently, the AC-to-DC stage 4 acts as a current source that outputs an output current having a sine-squared waveform. The waveform of the output current is therefore periodic with a frequency twice that of the input current and a ripple of 100%.

Owing to the ripple in the output current of the AC-to-DC stage 4, there are periods during which the current demanded by the load 7 is greater than the output current, and there are periods during which the current demanded by the load 7 is less than the output current. Hereafter these periods will be referred to as discharge periods and charge periods.

FIG. 3 illustrates the current demand of the load 7 and the output current of the

AC-to-DC stage 4 over a couple of cycles. In order to simplify the illustration, the output current is shown as a smooth waveform. However, it will be appreciated that the output current will have some high-frequency ripple at the switching frequencies of the PFC circuit 12 and the DC-to-DC converter 13. As can be seen in FIG. 3, there are discharge periods during which the current demand of the load 7 is greater than the output current of the AC-to-DC stage 4. The deficit in current is then made up by the battery 5. The load 7 therefore draws current from both the AC-to-DC stage 4 and the battery 5 during each discharge period. Needless to say, since current is drawn from the battery 5, the battery 5 discharges during each discharge period. It can also be seen that there are charge periods during which the current demand of the load 7 is less than the output current of the AC-to-DC stage 4. The surplus current is then used to charge the battery 5. The load 7 and the battery 5 therefore draw current from the AC-to-DC stage 4 during each charge period. As a result, the battery 5 acts as a smoothing capacitor for the AC-to-DC stage 4.

FIG. 4 illustrates the same waveforms as that of FIG. 3. The area of the region labelled A is representative of the total charge drawn from the battery 5 during each discharge period. The area of the region labelled B is representative of the total charge drawn by the battery 5 during each charge period. When the area of region A is greater than that of region B, there is net discharging of the battery 5. Conversely, when the area of region A is less than that of region B, there is net charging of the battery 5. There is then neither net charging nor net discharging of the battery 5 when the areas of the two regions are the same.

As is apparent from FIG. 4, the areas of regions A and B depend on the magnitude of the current demand of the load 7 and the amplitude of the output current of the AC-to-DC stage 4. The amplitude of the output current is defined by the amplitude of the input current drawn from the AC source 6. Accordingly, by adjusting the input current, the amplitude of the output current and thus the areas of regions A and B may be adjusted. As explained below, the PFC controller 20 adjusts the input current in response to changes in the voltage of the battery 5 and the power demand of the load 7.

The power supply 1 operates in one of two modes depending on whether or not the power supply 1 is connected to the AC source 6. When disconnected from the AC source 6, the power supply 1 operates in a first mode or battery mode. When connected to the AC source 6, the power supply 1 operates in a second mode or mains mode. The term ‘mains mode’ is used here since the AC source 6 is typically a mains power supply.

When operating in battery mode, the power demanded by the load 7 is supplied solely by the battery 5, which naturally discharges. When the voltage of battery 5 drops below a fully-discharged threshold, the power supply 1 disconnects the load 7 from the battery 5 to prevent any further discharge. This may be achieved via the internal protection circuitry of the battery 5. Alternatively, the power supply 1 may comprise a protection circuit (e.g. controller and switch) that monitors the voltage of the battery 5 and disconnects the load 7 from the battery 5 when the voltage of the battery 5 drops below the fully-discharged threshold.

When operating in mains mode, the power demanded by the load 7 is generally supplied by the AC source 6. That is to say that the power drawn from the AC source 6 is generally greater than that demanded by the load 7. Nevertheless, the load 7 draws current from both the AC-to-DC stage 4 and the battery 5, as will now be explained.

When operating in mains mode, the PFC controller 20 monitors the voltage of the battery 5 via the V_BAT signal. If the voltage of the battery 5 is below a fully-charged threshold, the PFC controller 20 regulates the input current drawn from the AC source 6 such that average output power of the AC-to-DC stage 4 is greater than the power demanded by the load 7. The surplus output power is then drawn by the battery 5, which experiences net charging. When the voltage of the battery 5 subsequently exceeds the fully-charged threshold, the PFC controller 20 decreases the input current such that the average output power is less than the power demanded by the load 7. The deficit in the output power is then supplied by the battery 5, which in turn discharges.

When the voltage of the battery 5 subsequently drops below a top-up threshold, the PFC controller 20 increases the input current such that the average output power is again greater than the power demanded by the load 7. As a result, the battery 5 again experiences net charging. The voltage of the battery 5 is therefore chopped between the fully-charged threshold and the top-up threshold.

When charging the battery 5 (i.e. when the voltage of the battery 5 is less than the fully-charged threshold), the AC-to-DC stage 4 regulates the input current drawn from the AC source 6 such that the battery 5 is charged with a constant average current. That is to say that the magnitude of the output current of the AC-to-DC stage 12, when averaged over each cycle, is constant. The output voltage of the AC-to-DC stage 4 is held at the voltage of the battery 5. Consequently, as the voltage of the battery 5 increases, a higher average output power is required in order to achieve the same average output current. The PFC controller 25 therefore adjusts the input current drawn from the AC source 6 in response to changes in the voltage of the battery 13. In particular, the PFC controller 25 increases the input current in response to an increase in the battery voltage.

Irrespective of whether the battery 5 experiences net charging or net discharging (i.e. irrespective of whether the average output power of the AC-to-DC stage 4 is greater than or less than the power demanded by the load 7), the battery 5 acts as a smoothing capacitor for the AC-to-DC stage 4. As noted above, the output current of the AC-to-DC stage 4 has a ripple of 100%. Consequently, over each cycle of the output current, there are two discharge periods during which the load current is greater than the output current, and a single charge period during which the load current is less than the output current. Net charging then occurs when the total charge drawn from the battery 5 during the discharge periods is less than the total charge drawn by the battery 5 during the charge period, i.e. when the average output power of the AC-to-DC stage 4 is greater than the power demanded by the load 7. Conversely, net discharging occurs when the total charge drawn from the battery 5 during the discharge periods is greater than the total charge drawn by the battery 5 during the charge period i.e. when the average output power of the AC-to-DC stage 4 is less than the power demanded by the load 7.

The load 7 has two different modes of operation: a low-power mode and a high-power mode, with the power demand of the load 7 being higher in high-power mode. If the average output power of the AC-to-DC stage 4 in low-power mode were the same as that in high-power mode, the rate at which the battery 5 charges and discharges would be higher in low-power mode. As a result, relatively high charge and/or discharge rates would occur in low-power mode which may damage the battery 5, or relatively slow charge rates would occur in high-power mode which may result in inordinately lengthy times to charge fully the battery 5. Accordingly, the AC-to-DC stage 4 adjusts the input current drawn from the AC source 6 in response to changes in the power demand of the load 7. In particular, when the load 7 operates in low-power mode, the PFC controller 20 decreases the input current such that the average output power of the AC-to-DC stage 4 is decreased. Conversely, when the load 7 operates in high-power mode, the PFC controller 20 increases the input current such that average output power of the AC-to-DC stage 4 is increased. As a result, similar or identical charge rates may be achieved in both power modes. For example, by ensuring that the difference in the output power of the AC-to-DC stage 4 when in low-power mode and high-power mode is the same as the difference in the power demands of the load 7, identical charge and discharge rates may be achieved in both power modes.

As explained above, the battery 5 of the power supply 1 acts as a high-capacity storage device for the AC-to-DC stage 4. Consequently it is not necessary for the PFC circuit 12 to comprise a capacitor of high capacitance, and thus a smaller and/or cheaper power supply 1 may be realised. The capacitor C1 of the PFC circuit 12 is required only to provide short-term storage of charge flowing between the PFC circuit 12 and the DC-to-DC converter 13. This is because the PFC circuit 12 and the DC-to-DC converter 13 typically operate at different frequencies. For example, the switch S1 of the PFC circuit 12 may operate at kHz frequencies, whilst the switches S2,S3 of the DC-to-DC converter 13 may operate at MHz frequencies. Nevertheless, owing to the relatively high frequencies at which the PFC circuit 12 and the DC-to-DC-converter 13 operate, a capacitor C1 of relatively low capacitance may be employed.

The provision of a PFC circuit in a power supply is commonplace. However, the PFC circuit typically comprises a current-control loop that regulates the input current and a voltage-control loop that regulates the output voltage. In contrast, the PFC circuit 12 of the present power supply 1 does not require a voltage-control loop. Instead, the AC-to-DC stage 4 is configured such that the voltage of the battery 5 is reflected back to the PFC circuit 12. As a result, it is not necessary for the PFC circuit 12 to regulate its output voltage. The voltage-control loop employed by a conventional PFC circuit may therefore be omitted, thus reducing the cost and/or complexity of the power supply 1. It will be noted that the PFC circuit 12 adjusts the amplitude of the current reference in response to changes in the voltage of the battery 5 and the power mode of the load 7. However, adjustment to the current reference is done solely to control the state of charge of the battery 5 rather than the voltage output by the PFC circuit 12. The PFC circuit 12 may therefore be said to employ a current-control loop and a charge-control loop. The current-control loop then regulates the input current drawn from the AC source 6, whilst the charge-control loop regulates the state of charge of the battery 5. The PFC circuit 12 does not, however, comprise a voltage-control loop for regulating the voltage output by the PFC circuit 12.

Since the output voltage of the AC-to-DC stage 4 is held at the battery voltage, there is no need for the DC-to-DC converter 13 to regulate the output voltage. The primary-side controller is therefore able to switch the primary-side switches S2,S3 at a fixed frequency. This then has the advantage that a relatively simple and cheap controller may be employed. By contrast, the DC-to-DC converter of a conventional power supply is generally required to regulate the output voltage. Consequently, where the DC-to-DC converter comprises an LLC series resonant converter, the primary-side controller is required to vary the frequency at which the primary-side switches are switched, thus requiring a more complex and expensive controller.

In the embodiment described above, the load 7 has two possible modes of operation: low-power mode and high-power mode. The load 7 then outputs the signal P_LOAD, which the PFC controller 20 uses to adjust the amplitude of the current reference. If, however, the load 7 had only one power mode or if the rates at which the battery 5 charges and discharges in either power mode are unimportant (e.g. perhaps the rates are within the rated limits of the battery 5), the signal P_LOAD may be omitted. Moreover, although the load 7 has two modes of operation, the load 7 might equally have a fewer or greater number of operating modes. For example, the load 7 may have an additional boost-power mode in which the power demanded by the load 7 is greater than the average output power of the AC-to-DC stage 4. The deficit power is then supplied by the battery 5, which in turn discharges. As a result, the battery 5 acts to supplement or boost the input power drawn from the AC source 6.

Whilst a particular embodiment has thus far been described, various modifications are possible without departing from the scope of the invention as defined by the claims. For example, whilst the provision of the EMI filter 10 has particular benefits and may indeed be required for regulatory compliance, it will be apparent from the discussions above that the EMI filter 10 is not essential and may be omitted.

In the embodiment described above, the PFC circuit 12 is located on the primary side of the DC-to-DC converter 13. Conceivably, however, the PFC circuit 12 may be located on the secondary side, as illustrated in FIG. 5. Although the PFC circuit 12 may be located on the secondary side, currents and thus losses will inevitably be higher.

The AC-to-DC stage 4 comprises an AC-to-DC converter 11 in the form of a bridge rectifier. However, where the PFC circuit 12 is located on the primary side of the DC-to-DC converter 13, the AC-to-DC converter 11 and the PFC circuit 12 may be replaced with a single bridgeless PFC circuit.

The PFC circuit 12 illustrated in FIGS. 2 and 5 comprises a boost converter. However, the PFC circuit 12 may equally comprise a buck converter, as illustrated in FIG. 6. It will therefore be apparent to a person skilled in the art that alternative configurations for the PFC circuit 12 are possible.

The PFC circuit 12 employs a current reference to regulate the input current drawn from the AC source 6. The PFC controller 20 then adjusts the current reference in response to changes in the voltage of the battery 5 and the power mode of the load 7. Conceivably, the PFC controller 20 may adjust the current reference in response to other parameters, such as the battery current or the battery temperature. Moreover, whilst in the above embodiment the current reference takes the form of a rectified sinusoid, the PFC circuit 12 may use other forms of current reference in order to regulate the input current drawn from the AC source 6. For example, the current reference may take the form of a PWM signal, which the PFC circuit 12 uses to regulate the input current. The PFC controller 20 may then adjust the current reference by adjusting the duty cycle or frequency of the PWM signal.

The DC-to-DC converter 13 has a centre-tapped secondary winding, which has the advantage that rectification may be achieved using two rather than four secondary-side devices. Rectification on the secondary side is then achieved using switches S4,S5 rather than diodes. Switches S4,S5 have the advantage of lower power losses, but the disadvantage of requiring a controller. However, since the primary-side switches S2,S3 operate at a fixed frequency, the secondary-side switches S4,S5 may also operate at a fixed frequency. Consequently, a relatively simple and cheap controller may also be employed on the secondary side. Moreover, a single, relatively cheap controller could conceivably be used to control both the primary-side and the secondary-side switches. In spite of these advantages, DC-to-DC converter 13 could comprise a non-tapped secondary winding and/or the secondary-side devices may be diodes. Moreover, rather than an LLC resonant converter, the DC-to-DC converter 13 may comprise an LC series or parallel resonant converter, or a series-parallel resonant converter.

In the embodiments described above, the AC-to-DC stage 4 comprises a PFC circuit 12 that provides power factor correction and a DC-to-DC converter 13 that steps down the voltage output by the PFC circuit 12. FIG. 7 illustrates an alternative embodiment in which a single converter 14 serves as both a PFC circuit and a DC-to-DC converter. The converter 14 is generally referred to as a flyback converter and has a conventional configuration, with one exception. The flyback converter 14 does not comprise a secondary-side capacitor.

The flyback converter 14 comprises a PFC controller 20 for controlling the primary-side switch S1. The operation of the PFC controller 20 is largely unchanged from that described above. In the embodiments described above, the PFC controller 20 operates in continuous-conduction mode. In contrast, the PFC controller 20 of the flyback converter 14 operates in discontinuous-conduction mode. However, in all other respects the operation of the PFC controller 20 is unchanged.

In contrast to that illustrated in FIG. 3, the output current of the AC-to-DC stage 4 is not smooth but instead comprises a plurality of pulses. Nevertheless, as can be seen in

FIG. 8, the waveform of the output current continues to be periodic with a frequency twice that of the input current and a ripple of 100%. The waveform of the output current illustrated in FIG. 3 arises because the PFC controller 20 employs a control scheme that ensures continuous conduction. Conceivably, the PFC controller 20 may employ a control scheme that results in discontinuous conduction. In this instance, the output current of the AC-to-DC stage 4 would likewise comprise a plurality of pulses. Accordingly, whilst the AC-to-DC stage 4 may be said to generate an output current having a waveform that is periodic with a frequency twice that of the input current drawn from the AC source 6, it will be appreciated that the waveform may be composed of a plurality of discrete pulses. Where the output current is composed of discrete pulses, there will be a plurality of discharge periods and a plurality of charge periods over each cycle of the output current.

In the embodiments illustrated in FIGS. 2, 5 and 6, the turns ratio of the DC-to-DC converter 13 is defined such that the stepped battery voltage is always greater than the peak value of the input voltage of the AC source 6; this is important for ensuring that the PFC circuit 12 is able to control current continuously. However, with the flyback converter 14 of FIG. 7, the voltage of the battery 5 is not reflected back to the primary-side capacitor C2. Consequently, it is not necessary to define a particular turns ratio in order to achieve continuous current control. Consequently, the turns ratio of the flyback converter 14 may be defined so as to optimise the efficiency of the power supply 1.

In spite of the advantages of the flyback converter 14 (e.g. fewer components and simpler control), the converter 14 suffers from the disadvantage that the transformer Tx is responsible for storing all energy that is transferred from the primary side to the secondary side. Consequently, as the required output power of the AC-to-DC stage 4 increases, the size of the transformer and/or the switching frequency must increase. The provision of a flyback converter 14 is therefore advantageous when the power demand of the load 7 is relatively low (e.g. below 200 W). At higher power, an alternative topology, such as that illustrated in FIG. 2, 5 or 6, is preferable.

Returning to the embodiments illustrated in FIGS. 2, 5 and 6, the provision of a DC-to-DC converter 13 has the advantage that the power supply 1 may comprise a battery 5 having a voltage that is lower than the peak value of the input voltage. However, there may be applications for which the DC-to-DC converter 13 may be omitted. FIG. 9 illustrates an embodiment in which the DC-to-DC converter 13 is omitted. Since the DC-to-DC converter 13 is omitted, the PFC circuit 12 no longer requires a capacitor. In order that the PFC circuit 12 can continue to control current continuously, the minimum operating voltage of the battery 5 must be greater than the peak value of the input voltage of the AC source 6, i.e. V_BAT(min)>V_IN(peak). Consequently, if the AC source 6 is a mains power supply providing a peak voltage of 120 V, the battery 5 must have a minimum voltage of at least 120 V. Whilst such an arrangement requires a high-voltage battery, there may be some applications for which this arrangement is both practical and advantageous.

In all of the embodiments described above, the output current of the AC-to-DC stage 4 has a ripple of 100%. This arises because the AC-to-DC stage 4 has little or no storage capacitance. Conceivably, the AC-to-DC stage 4 may output an output current having a smaller ripple. This may be desirable for at least two reasons. First, the rates at which the battery 5 charges and discharges during each charge and discharge period would be slower. Additionally, the total charge drawn by and from the battery 5 during each charge and discharge period would be smaller. One or both of these factors might help prolong the life of the battery 5. Second, for the same average output power of the AC-to-DC stage 4, the peak value of the output current will be smaller and thus a smaller and/or cheaper filter inductor L2, having a lower current rating, may be used. Decreasing the ripple in the output current may be achieved by operating the DC-to-DC converter 13 at a frequency higher than resonance. This then increases the impedance of the DC-to-DC converter 13, thereby allowing a voltage differential to arise between the PFC circuit 12 and the battery 5. This voltage differential may then be used to shape the output current such that it has a ripple less than 100%. However, any reduction in ripple will require additional capacitance. Accordingly, the AC-to-DC stage 4 is preferably configured such that the output current has a ripple of least 50%.

When the power supply 1 is employed with a product, the power supply 1 as a whole may be located inside or outside the product. Alternatively, a part only of the power supply 1 may be located inside the product. So, for example, where the product is a vacuum cleaner, the power supply 1 as a whole may be located inside the main body of the vacuum cleaner, and the vacuum cleaner may comprise a power cord for connecting the input terminals of the power supply 1 to a mains power socket. Alternatively, the battery 5 only may be located inside the vacuum cleaner, and the AC-to-DC stage 4 may form a separate unit located outside the vacuum cleaner. In this regard, the division of the power supply 1 into two parts would resemble the situation typically found in laptop computers, in which the battery is located inside the computer and the AC-to-DC stage forms a separate unit located outside the computer.

FIG. 10 illustrates a vacuum cleaner 30 that comprises the power supply 1 of FIGS. 1 and 2. The vacuum cleaner 30 further comprises a main body 31, a vacuum motor 32, and a power cord 33. The power supply 1 and the vacuum motor 32 are housed within the main body 31. More particularly, the AC-to-DC stage 4 is housed in an upper part of the main body 31 whilst the battery 5 is housed in a lower part. The vacuum motor 32 is connected to the output terminals 3 of the power supply 1. One end of the power cord 33 is connected to the input terminals 2 of the power supply 3, whilst the other end is connectable to a mains power supply. When connected to the mains power supply, the power supply 1 operates in mains mode. Conversely, when disconnected from the mains power supply, the power supply 1 operates in battery mode. The power cord 33 can be disconnected from the power supply 1 so that the power cord 33 may be discarded when operating the vacuum cleaner 30 in battery mode.

1. A power supply comprising:
input terminals for connection to an AC source;
output terminals for connection to a load;
an AC-to-DC stage; and
a battery,
wherein the AC-to-DC stage and the battery are connected in parallel between the input terminals and the output terminals, the power supply operates in either a first mode or a second mode, the load draws current from only the battery when operating in the first mode, the load draws current from both the battery and the AC-to-DC stage when operating in the second mode, and when operating in the second mode:
the AC-to-DC stage draws an input current from the AC source and outputs an output current having a waveform that is periodic with a frequency twice that of the input current and a ripple of at least 50%;
the current drawn by the load is greater than the output current during one or more first periods;
the current drawn by the load is less than the output current during one or more second periods;
the load draws current from the battery and the AC-to-DC stage during the first periods such that the battery discharges; and
the load and the battery each draw current from the AC-to-DC stage during the second periods such that the battery charges.

2. The power supply of claim 1, wherein there is at least one first period and at least one second period over each cycle of the output current.

3. The power supply of claim 1, wherein the AC-to-DC stage adjusts the input current in response to changes in one of: (i) a voltage of the battery, (ii) a current drawn from or by the battery, (iii) a temperature of the battery, or (iv) a power demand of the load.

4. The battery charger of claim 1, wherein the AC-to-DC stage adjusts the input current in response to changes in the voltage of the battery such that the average value of the output current is constant.

5. The power supply of claim 1, wherein, when the voltage of the battery rises above an upper threshold, the AC-to-DC stage adjusts the input current such that, over each cycle of the output current, the charge drawn from the battery during the first periods is greater than the charge drawn by the battery during the second periods.

6. The power supply of claim 1, wherein, when the voltage of the battery drops below a lower threshold, the AC-to-DC stage adjusts the input current such that, over each cycle of the output current, the charge drawn from the battery during the first periods is less than the charge drawn by the battery during the second periods.

7. The power supply of claim 1, wherein the load has a low-power mode and a high-power mode, the power demand of the load is lower in low-power mode, and the AC-to-DC stage adjusts the input current such that the output current is lower when the load is in low-power mode.

8. The power supply of claim 1, wherein the AC-to-DC stage comprises a PFC circuit that regulates the input current drawn from the AC source but does not regulate the output voltage of the AC-to-DC stage.

9. The power supply of claim 8, wherein the PFC circuit employs a current reference for regulating the input current drawn from the AC source, and the PFC circuit adjusts the current reference in response to changes in one of: (i) the voltage of the battery, (ii) the current drawn from or by the battery, (iii) the temperature of the battery, or (iv) the power demand of the load.

10. The power supply of claim 1, wherein the AC-to-DC stage comprises a step-down DC-to-DC converter having a voltage conversion ratio greater than [[the]]a peak value of the input voltage of the AC source divided by a minimum voltage of the battery.

11. The power supply of claim 1, wherein the AC-to-DC stage comprises a step-down DC-to-DC converter having one or more primary-side switches that are switched at a constant frequency.

12. The power supply of claim 11, wherein the DC-to-DC converter has one or more secondary-side switches that are switched at the same constant frequency.

13. An electrical system comprising a load connected to the output terminals of a power supply of claim 1.

14. The electrical system of claim 13, wherein, over each cycle of the output current, the current drawn by the load has a ripple less than 10%.

15. The electrical system as claimed in of claim 13, wherein the load comprises an electric motor.

16. A vacuum cleaner comprising a vacuum motor connected to the output terminals of a power supply of claim 1.
